(19) United States
(12) Patent Application Publication
(10) Pub. No.: US 2025/0199474 A1
(43) Pub. Date: Jun. 19, 2025

(54) HOROLOGICAL ASSEMBLY FOR A REGULATING MEMBER PROVIDED WITH RATE ADJUSTMENT MEANS

(71) Applicant: The Swatch Group Research and Development Ltd, Marin (CH)

(72) Inventors: Mohammad Hussein KAHROBAIYAN, Boudevilliers (CH); Romain Le Moal, Billers-le-Lac (FR); Julien Christan, Bienne (CH); Jonathan Meyer, Bienne (CH)

(73) Assignee: The Swatch Group Research and Development Ltd, Marin (CH)

(21) Appl. No.: 18/934,446

(22) Filed: Nov. 1, 2024

(30) Foreign Application Priority Data
Dec. 19, 2023 (EP) 23218171.9

(51) Int. Cl. G04B 17/06; G04B 18/00; G04B 18/02; G04B 18/06

(52) U.S. Cl. CPC G04B 17/063; G04B 18/006; G04B 18/021; G04B 18/023; G04B 18/06

(57) ABSTRACT

A horological assembly for a horological regulating member, including a balance spring (25) having a coiled flexible strip (2); a device for adjusting its rigidity which includes a flexible element (5) arranged in series with the strip and connecting one end (4) of said strip to a rigid support (17), the flexible element having a rigidity greater than that of the strip. The adjustment device includes a pre-stressing device (6) for applying a variable force or torque to the flexible element to vary the rigidity of the flexible element. A stud-holder (1) is configured to suspend the balance spring and includes a main body (30) connected to the flexible element, and a secondary body (33) connected to the pre-stressing device, the secondary body (33) being movable relative to the main body (30) and being connected to the main body by a flexure bearing (20).

### CROSS REFERENCE TO RELATED APPLICATION

This application claims priority to European Patent Application No. 23218171.9 filed Dec. 19, 2023, the entire contents of which are incorporated herein by reference.

### TECHNICAL FIELD OF THE INVENTION

The invention relates to a horological assembly for a regulating member provided with rate adjustment means.

The invention further relates to a regulating member comprising such a horological assembly.

### TECHNOLOGICAL BACKGROUND

Most mechanical watches today are equipped with a sprung balance and a Swiss lever escapement mechanism. The sprung balance constitutes the time base of the watch. It is also referred to as a resonator.

The escapement has two main functions:
to maintain the two-and-fro motions of the resonator;
to count these to-and-fro motions.

An inertial element, a guide and a resilient return element are required in order to constitute a mechanical resonator. Conventionally, a balance spring acts as a resilient return element for the inertial element constituted by a balance. This balance is guided in rotation by pivots which rotate inside plain ruby bearings.

The balance spring typically needs to be adjustable to improve the accuracy of a watch. To this end, means are used to adjust the rigidity of the balance spring, such as an index for modifying the effective length of the spring. Its rigidity is therefore modified in order to adjust the accuracy of the watch's rate. However, the effect of a conventional index assembly for adjusting the rate remains limited, and it is not always effective in making a sufficiently accurate adjustment, to the order of a few seconds or a few tens of seconds per day.

Other balance springs have integrated adjustment means. In these balance springs, the rate is not regulated by altering the effective length of the balance spring, but by applying a force or torque to a flexible element arranged in series with the balance spring. In this way, the stiffness of the flexible element and consequently of the balance spring as a whole can be modified. Adjusting the stiffness of the balance spring allows the rate of the regulating member to be regulated. Such a balance spring provided with a flexible element is described, for example, in patent applications EP4009115 and CH0700385/2021.

In these cases, the usual systems cannot be used, as they are not compatible with the balance spring regulating device. Moreover, as the rate has to be regulated to a very fine degree, it is essential that there is no play between the balance spring and the areas where it interacts with the index assembly. More specifically, if this were not the case, there would be a risk of the rate being altered in the event of an impact, if the balance spring does not reposition itself in exactly the same way after the impact.

To use such a balance spring, an index system has been described in patent applications EP22177059.7 and CH000678/2022. The index system comprises a stud-holder in two parts that can move relative to each other, each part being provided with a stud on which the flexible element is mounted on the one hand, and the prestressing means acting on the flexible element on the other. Thus, by moving the two parts relative to each other, the force or torque applied to the flexible element is modified, in order to adjust the stiffness of the balance spring.

However, this index system is complex to implement. It also takes up a lot of space on the regulating member.

### SUMMARY OF THE INVENTION

The aim of the present invention is to overcome some or all of the aforementioned drawbacks by providing a horological assembly for a regulating member provided with efficient and precise rate adjustment means.

To this end, the invention relates to a horological assembly for a horological regulating member, said horological assembly comprising a balance spring comprising a flexible strip wound about itself in a plurality of turns, the strip having a predefined rigidity, the balance spring comprising means for adjusting its rigidity, the adjustment means comprising a flexible element arranged in series with the strip, the flexible element connecting one end of said strip to a rigid support, the flexible element preferably having a rigidity greater than that of the strip, the adjustment means comprising prestressing means for applying a variable force or torque to the flexible element, so as to vary the rigidity of the flexible element, said horological assembly comprising a stud-holder configured to suspend the balance spring, the stud-holder comprising a main body connected to the flexible element, and a secondary body connected to the prestressing means, the secondary body being movable relative to the main body.

The invention is characterised in that the secondary body is connected to the main body by a flexure bearing.

The invention thus provides adjustment means that are simpler to implement and that have limited dimensions. More specifically, it comprises a stud-holder comprising two bodies connected by a flexure bearing. The main body is connected to the flexible element, whereas the secondary body is connected to the prestressing means. The position of the secondary body in relation to the main body simply needs to be changed to actuate the prestressing means and adjust the rate of the regulating member.

According to a particular embodiment of the invention, the pivot with non-crossing blades comprises two flexible blades connecting the main body to the secondary body.

According to a particular embodiment of the invention, the flexure bearing is configured to allow the secondary body to move substantially in a first direction D1, which direction is preferably circular.

According to a particular embodiment of the invention, the flexure bearing is arranged to prevent the secondary body from moving substantially in a second direction D2.

According to a particular embodiment of the invention, the second direction D2 is substantially perpendicular to the first direction D1.

According to a particular embodiment of the invention, the main body comprises a first stud on which the flexible element is mounted.

According to a particular embodiment of the invention, the secondary body comprises a second stud on which the prestressing means are mounted.

According to a particular embodiment of the invention, the prestressing means comprise a lever connected to the flexible element.

According to a particular embodiment of the invention, the lever comprises an end that can move in said first direction D1, the end being mounted on the second stud.

According to a particular embodiment of the invention, the horological assembly comprises an actuator for moving the secondary body relative to the main body.

According to a particular embodiment of the invention, the actuator is a screw.

According to a particular embodiment of the invention, the actuator is a cam.

According to a particular embodiment of the invention, the flexible element comprises a flexible blade.

According to a particular embodiment of the invention, the torque or force can be adjusted continuously by the prestressing means.

The invention further relates to a regulating member, in particular for a horological movement, which regulating member comprises such a horological assembly.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a perspective, top view of a horological assembly for a regulating member according to one embodiment of the invention,

FIG. 2 diagrammatically shows a bottom view of the horological assembly in FIG. 1,

FIG. 3 diagrammatically shows a perspective bottom view of the horological assembly in FIG. 1, and

FIG. 4 diagrammatically shows a perspective top view of a part of a regulating member in FIG. 1.

### DETAILED DESCRIPTION OF THE INVENTION

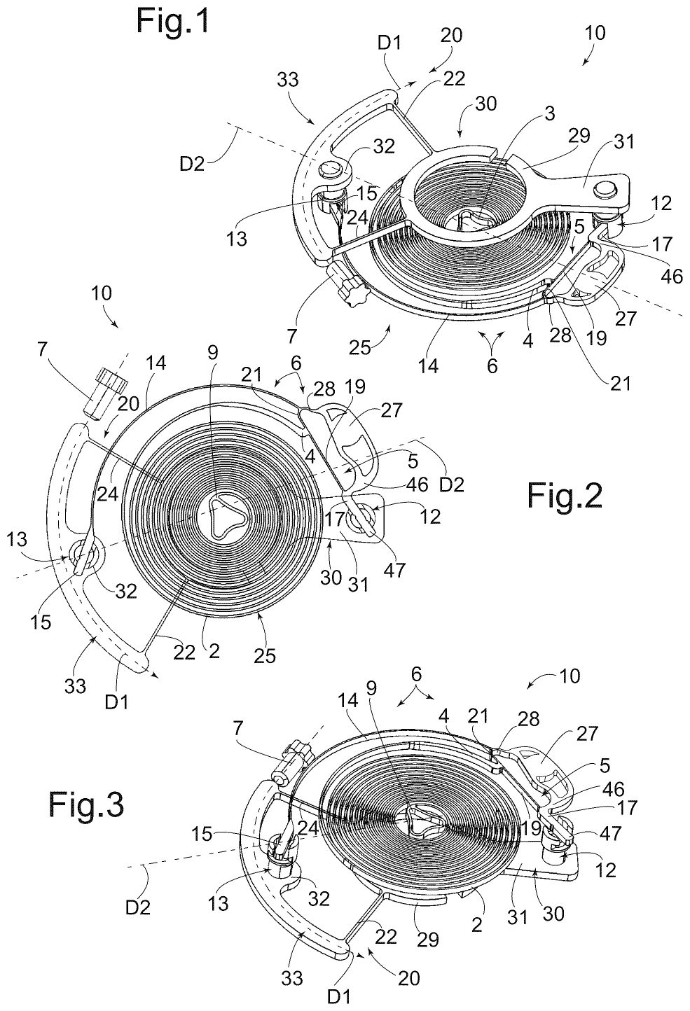

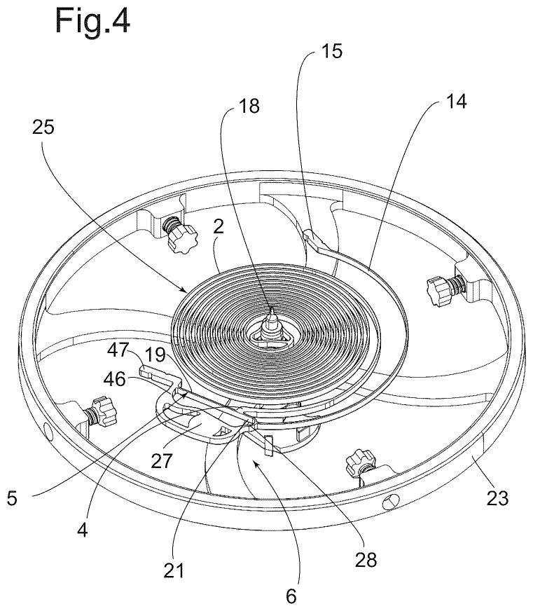

FIGS. 1 to 4 diagrammatically show an embodiment of a horological assembly 10 comprising a stud-holder 1 and a balance spring 25 for a regulating member intended to be arranged in a horological movement not shown in the figures.

Such a horological movement comprises, for example, a plate provided with a recess for receiving the regulating member, the regulating member being provided with an inertial mass, and a resilient return element for the inertial mass configured to cause it to oscillate.

The regulating member further comprises an annular balance 23 as an inertial mass, a balance staff 18 and a balance cock, not shown in the figures. For example, the balance 23, the balance spring 25 and the balance cock are stacked from bottom to top.

The balance staff is centred and passes through the centre of the balance 23, of the balance spring 25 and of the balance cock. The balance staff 18 is held by two shock-resistant bearings (not shown in the figures), which are arranged at both ends of the balance staff 18. A first bearing, not shown in the figures, is arranged under the balance 23 and the balance cock, and the second bearing is held by the balance cock. The balance cock has, for example, a through-hole inside which the second bearing is held. The stud-holder 1 is, for example, mounted on the balance cock and is arranged along the central axis of the balance staff.

The balance spring 25 preferably extends substantially in one plane. The balance spring 25 comprises a flexible strip 2 wound about itself in several turns, the strip 2 having a predefined stiffness. The inside end 9 of the strip 2 is integral with or assembled with a support 3, typically referred to as a collet. The support 3 here is substantially triangular in shape and is intended to be threaded around the staff of the balance.

The balance spring 25 further includes means for adjusting its stiffness. For example, the adjustment means can in particular be actuated by a user when the regulating member is mounted in the horological movement.

The adjustment means comprise a flexible element 5 arranged in series with the strip 2, i.e. following on from the strip, preferably as an extension thereof, the flexible element 5 connecting an outside end 4 of said strip 2 to a rigid support 17. The flexible element 5 is integral with the outside end 4 of the strip 2. The flexible element 5 is a different element from the strip 2.

The flexible element 5 adds additional stiffness to that of the strip 2. The flexible element 5 is preferably stiffer than the strip 2. In this case, the flexible element 5 is arranged as an extension of the strip 2. Preferably, the adjustment means and the strip 2 are in one piece, or even made of the same material, for example silicon.

The flexible element 5 of the balance spring 25 comprises a first flexible blade 19, which extends from the outside end 4 of the strip 2, and is connected to the first flexible blade 19. The first flexible blade 19 is also connected to the rigid support 17.

The rigid support 17 is L-shaped, with a first leg 46 of the L serving as a connection to the first flexible blade 19, and the second leg 47 of the L facing away from the first flexible blade 19 so that it can be assembled to the stud-holder 1.

The means for adjusting the balance spring 25 further include prestressing means 6 for applying a variable force or torque to the flexible element 5. In this way, the stiffness of the balance spring 1 can be adjusted. The torque or force is continuously adjustable thanks to the prestressing means 6. In other words, the torque or force is not restricted to isolated values. The stiffness of the flexible element 5 can thus be adjusted with great precision.

The prestressing means 6 comprise a secondary flexible blade 21, arranged as an extension of the first flexible blade 19, on the other side of the outside end 4.

The other end of the secondary flexible blade 21 is connected to a curved lever 14 which runs around the strip 2. The lever 14 is connected, in addition to the secondary flexible blade 21, to a semi-rigid structure 27 attached to the rigid support 17. The semi-rigid structure 27 deforms in part when the lever 14 is actuated by the force or torque. The semi-rigid structure 27 comprises a flexible curved blade 28 joining the lever 14.

The force or torque is exerted on the free end 15 of the lever 14. In this way, the lever 14 of the prestressing means 6 transmits the force or torque to the flexible element 5 via the secondary flexible blade 21 and via the curved blade 28 of the semi-rigid structure 27, so as to modify the stiffness of the balance spring 25.

The stud-holder 1 is configured to suspend the balance spring 25 and to allow the adjustment means to be actuated.

To this end, the stud-holder 1 comprises a main body 30 intended to be mounted on the balance cock and to be connected to the flexible element 5.

The stud-holder 1 further includes a secondary body 33 that is movable relative to the main body 30. The secondary body 33 is connected to the prestressing means 6.

The main body 30 comprises a first stud 12 on which the flexible element 5 of the balance spring 25 is mounted, whereas the secondary body 33 comprises a second stud 13 on which the end 15 of the lever 14 of the prestressing means 6 is mounted.

The main body 30 comprises a central ring 29 and a first arm 31. The first stud is mounted on the first arm 31, preferably at its end.

The secondary body 33 comprises a protrusion 32 provided with an opening in which the second stud 13 is mounted. The protrusion 32 extends from the inside of the arc of a circle.

The first stud 12 and the second stud 13 extend perpendicularly to the plane of the stud-holder 1 to hold the balance spring 25 in a plane substantially parallel to the plane of the stud-holder 1.

Thus, by moving the secondary body 33 relative to the main body 2, the lever 14 of the prestressing means 6 is actuated.

An actuator 7 is configured to move the secondary body 33 relative to the main body 30. Such an actuator 7 is, for example, a screw, or a cam (not shown in the figures), configured to apply a displacement force to the secondary body 33.

For example, the screw is mounted on a support for the horological movement, not shown in the figures. The support is configured to allow the screw to move substantially in the direction D1.

The screw is directed in a first direction D1 in which direction the secondary body 33 moves. Thus, when the screw is actuated, the secondary body 33 moves in this direction D1. The direction D1 is substantially circular.

As a result, the end 15 of the lever 14 of the prestressing means 6 moves substantially in the direction D1, and modifies the torque or force exerted on the flexible element 5, and thus changes the rigidity and rate of the regulating member.

According to the invention, the secondary body 33 is connected to the main body 30 by a flexure bearing, which makes it possible to modify the position of the secondary body 33 relative to the main body 30, in particular in the first direction D1.

Moreover, the flexure bearing prevents the secondary body 33 from moving substantially in a second direction D2. The second direction D2 is substantially perpendicular to the first direction D1 of the end 15 of the lever 14 and of the actuator 7. Thus, the lever 14 is prevented from moving in this second direction D2, in particular to prevent the rate adjustment from being distorted. The direction D2 is substantially radial.

More specifically, if the stud-holder 1 and the balance spring 25 move relative to the actuator 7, the friction caused by the contact between the actuator 7 and the stud-holder 1 can cause the lever 14 to move laterally, resulting in a precision error in the rate adjustment.

In this embodiment, the flexure bearing 20 comprises a pivot with non-crossing blades connecting the main body 30 to the secondary body 33.

The secondary body 33 is arc-shaped. The pivot with non-crossing blades is provided with two flexible blades 22, 24 extending away from each other, from the central ring 29 of the main body 30, as far as the secondary body 33, preferably as far as the ends of the secondary body 33.

Preferably, the two flexible blades 22, 24 are approximately the same length.

Thanks to the flexure bearing 20, the secondary body 33 can move mainly in the first, substantially circular direction D1, but not in the second, substantially radial direction D2. This is because the flexible blades 22, 24 retain the secondary body 33 in this second direction D2, but allow the lever to move in the first direction D1.

The invention further relates to a regulating member, in particular for a horological movement. The regulating member comprises an oscillating weight and a horological assembly 10 as described above.

It goes without saying that the invention is not limited to the embodiments of regulating members described with reference to the figures and alternatives can be considered without leaving the scope of the invention.

1. A horological assembly for a horological regulating member, said horological assembly (10) comprising;
a balance spring (25) including a flexible strip (2) wound about itself in a plurality of turns, the strip (2) having a predefined rigidity and adjusting means for adjusting its rigidity, the adjustment means comprising a flexible element (5) arranged in series with the strip (2), the flexible element (5) connecting one end (4, 9) of said strip (2) to a rigid support (17), the flexible element (5) preferably having a rigidity greater than that of the strip (2), the adjustment means further comprising prestressing means (6) for applying a variable force or torque to the flexible element (5), so as to vary the rigidity of the flexible element (5); and
a stud-holder (1) configured to suspend the balance spring (25), the stud-holder (1) comprising a main body (30) connected to the flexible element (5), and a secondary body (33) connected to the prestressing means (6), the secondary body (33) being movable relative to the main body (30), wherein the secondary body (33) is connected to the main body (30) by a flexure bearing (20).

2. The horological assembly according to claim 1, wherein the flexure bearing (20) comprises a pivot with non-crossing blades comprising two flexible blades (22, 24) connecting the main body (30) to the secondary body (33).

3. The horological assembly according to claim 1, wherein the flexure bearing (20) is configured to allow the secondary body (33) to move substantially in a first direction (D1), which direction is preferably circular.

4. The horological assembly according to claim 1, wherein the flexure bearing (20) is arranged to prevent the secondary body (33) from moving substantially in a second direction (D2).

5. The horological assembly according to claim 4, wherein the second direction (D2) is substantially perpendicular to the first direction (D1).

6. The horological assembly according to claim 1, wherein the main body (30) comprises a first stud (12) on which the flexible element (5) is mounted.

7. The horological assembly according to claim 1, wherein the secondary body (33) comprises a second stud (13) on which the prestressing means (6) are mounted.

8. The horological assembly according to claim 1, wherein the prestressing means (6) comprise a lever (14) connected to the flexible element (5) in order to apply the variable force or torque.

9. The horological assembly according to claim 7, wherein the lever (14) comprises an end (15) that can move in said first direction (D1), the end (15) being mounted on the second stud (13).

10. The horological assembly according to claim 1, wherein it comprises an actuator (7) for moving the secondary body (33) relative to the main body (30).

11. The horological assembly according to claim 10, wherein the actuator (7) is a screw.

12. The horological assembly according to claim 10, wherein the actuator (7) is a cam.

13. The horological assembly according to claim 1, wherein the flexible element (5) comprises a flexible blade (19).

14. The horological assembly according to claim 1, wherein the torque or force is continuously adjustable thanks to the prestressing means (6).

15. A regulating member, comprising the horological assembly (10) according to claim 1.
